(19) United States
(12) Patent Application Publication
(10) Pub. No.: US 2026/0039214 A1
(43) Pub. Date: Feb. 5, 2026

(54) BALANCED SOLID STATE TRANSFORMER CIRCUIT AND METHOD OF REDUCING ELECTROMAGNETIC INTERFERENCE THEREOF

(71) Applicant: The United States of America, As Represented by the Secretary of the Navy, Arlington, VA (US)

(72) Inventors: Giovanna Maria Oriti, Seaside,, CA (US); Alexander Lloyd Julian, Seaside, CA (US)

(21) Appl. No.: 18/791,904

(22) Filed: Aug. 1, 2024

(51) Int. Cl. H02M 3/335; H02M 1/44

(52) U.S. Cl. CPC H02M 3/33584; H02M 1/44

(57) ABSTRACT

A balanced bi-directional CLLC transformer circuit comprising: a first converter comprising a first set of switches; a second converter comprising a second set of switches; a transformer; a primary resonant circuit; and a secondary resonant circuit; wherein the first converter and the primary resonant circuit are electrically coupled to a primary winding of the transformer; wherein the second converter and the secondary resonant circuit are electrically coupled to a secondary winding of the transformer; wherein the primary resonant circuit is balanced across the primary winding of the transformer; and wherein the secondary resonant circuit is balanced across the secondary winding of the transformer.

### STATEMENT OF GOVERNMENT INTEREST

The present disclosure was made in the performance of official duties by one or more employees of the Department of the Navy, and thus, embodiments herein may be manufactured, used, or licensed by or for the Government of the United States of America for governmental purposes without the payment of any royalties thereon or therefor.

### FIELD OF USE

The present disclosure relates, in general, to an apparatus for and method of reducing electromagnetic interference (EMI) in wide bandgap capacitor-inductor-inductor-capacitor (CLLC) resonant converters. More specifically, the present disclosure relates to a balanced bi-directional CLLC solid-state transformer (SST).

### BACKGROUND

Generally, bi-directional isolated direct current (DC/DC) converters, also known as solid-state transformers (SST), are power electronics that efficiently convert a direct current (DC) from one voltage to another voltage and are widely used in microgrid and transportation electrification applications.

There are two types of DC/DC converters: linear and switched. A linear DC/DC converter uses a resistive voltage drop to create and regulate a given output voltage; a switched-mode DC/DC converts by storing the input energy periodically and then releasing that energy to the output at a different voltage. The storage can be in either a magnetic field component, such as an inductor or a transformer, or an electric field component, such as a capacitor. Transformer-based converters provide isolation between the input and the output. A disadvantage of a switch mode DC/DC converter is that they are electrically noisy and may produce electromagnetic interference (EMI).

When power semiconductor devices switch quickly, they create conducted and radiated EMI. Faster switching times in power electronics can lead to faster voltage and current signal rise and fall times, which produce more energy at high frequencies. These harmonics are the leading cause of EMI in DC/DC converters.

Electromagnetic interference (EMI) is unwanted noise or interference in an electrical circuit or path caused by an external source. EMI is also known as radio frequency interference (RFI) in the radio frequency spectrum. EMI can be transmitted through radiated or conducted paths, or both, from one electronic device to another. EMI can be caused by inherent noise created within an electrical device by thermal agitation, such as electrons moving through a circuit resistor; natural EMI caused by natural events, such as lightning, electric storms, loud sounds, or the Earth's magnetic fields; human-made EMI produced by electronic equipment, such as cell phones, medical equipment, microwave ovens, and speakers, harmonic magnetic fields, and RF fields.

EMI is further classified into common mode (CM) and differential mode (DM) EMI. DM EMI is a conducted electromagnetic interference (EMI) noise between two conductors within a cable or on a printed circuit board (PCB) and is characterized by two signals 180 degrees out of phase and flowing in opposite directions on the wire. CM EMI occurs along the lines of a closed loop simultaneously, in the same direction and in phase current with respect to a common reference ground. It is usually caused by high-frequency currents flowing in the same direction down both interconnect lines and through the parasitic capacitance of diodes, transistors, and transformers to ground in a power circuit.

DC/DC converters typically produce conducted and radiated common mode EMI.

Therefore, what is needed is an apparatus or method of reducing common mode EMI produced by DC/DC converters.

### SUMMARY

To minimize the limitations in the prior art, and to minimize other limitations that will become apparent upon reading and understanding the present specification, the present disclosure discloses a new and useful balanced bi-directional CLLC solid-state transformer (SST).

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented herein below. It is to be understood that both the following general description and the following detailed description are exemplary and explanatory only and are not restrictive.

The common mode EMI problem of wide bandgap capacitor-inductor-inductor-capacitor (CLLC) resonant converters is solved by distributing the capacitance and inductance across the transformer to balance the circuit.

Common mode (CM) electromagnetic interference (EMI) is a simultaneous and in-phase current that occurs along the closed loop lines with respect to a common reference ground. This interference is particularly pronounced at higher switching rates or frequencies in DC-DC converters. To mitigate this, the inductance and capacitance of the resonant circuits can be strategically distributed across the primary and secondary windings of a transformer, effectively reducing and filtering CM EMI on both sides of the circuit.

One embodiment of the present disclosure may comprise a balanced bi-directional SST circuit which may include power source, decoupling capacitor, converter, first resonant inductor, first resonant capacitor, transformer primary winding, transformer secondary winding, third resonant capacitor, third resonant inductor, converter, decoupling capacitor, load, fourth resonant inductor, fourth resonant capacitor, second resonant capacitor, second resonant inductor, and controller, which are operatively and electrically connected to each other. By distributing the inductance and the capacitance of the resonant circuits across the windings of a transformer, the impedance of an electrical source and load are not changed, but the improved filtering characteristics of the balance circuit may significantly reduce CM EMI.

Another embodiment of the present disclosure may comprise a balanced bi-directional capacitor-inductor-inductor-capacitor transformer circuit comprising: a transformer comprising a primary winding and a secondary winding; a first converter comprising a first set of switches, the first converter being electrically coupled to the primary winding of the transformer; a second converter comprising a second set of switches, the second converter being electrically coupled to the secondary winding of the transformer; a primary resonant circuit that may be: balanced across the primary winding of the transformer and filters common mode electromagnetic interference (EMI), and electrically coupled to the primary winding of the transformer; and a secondary resonant circuit that may be: balanced across the secondary winding of the transformer and the filters common mode EMI, and electrically coupled to the secondary winding of the transformer. The primary resonant circuit further comprising a Va1 tank circuit and a Vb1 tank circuit; the secondary resonant circuit further comprising a Va2 tank circuit and a Vb2 tank circuit; the Va1 tank circuit further comprising an impedance, the Vb1 tank circuit further comprising an impedance, the Va1 tank circuit impedance being equivalent to the Vb1 tank circuit impedance; and the Va2 tank circuit further comprising an impedance, the Vb2 tank circuit further comprising an impedance, the Va2 tank circuit impedance being equivalent to the Vb2 tank circuit impedance. The Va1 tank circuit being electrically coupled to an L1 of the primary winding of the transformer; the Vb1 tank circuit being electrically coupled to an L2 of the primary winding of the transformer; the Va2 tank circuit being electrically coupled to an L1 of the secondary winding of the transformer; and the Vb2 tank circuit being electrically coupled to an L2 of the secondary winding of the transformer. The Va1 tank circuit comprising a first resonant inductor and a first resonant capacitor, and the first resonant inductor and the first resonant capacitor of the Va1 tank circuit being electrically coupled; the Vb1 tank circuit comprising a second resonant inductor and a second resonant capacitor, and the second resonant inductor and the second resonant capacitor of the Vb1 tank circuit being electrically coupled; the Va2 tank circuit comprising a third resonant inductor and a third resonant capacitor, and the third resonant inductor and the third resonant capacitor of the Va2 tank circuit being electrically coupled; and the Vb2 tank circuit comprising a fourth resonant inductor and a fourth resonant capacitor, and the fourth resonant inductor and the fourth resonant capacitor of the Vb2 tank circuit being electrically coupled. The primary resonant circuit and the secondary resonant circuit comprise a total resonant capacitance; and the total resonant capacitance being:

$${C}_{res} = \frac{1}{\frac{1}{{C}_{rp}} + \frac{1}{{C}_{r p}} + \frac{{N}_{p}^{2}}{{C}_{r s} {N}_{s}^{2}} + \frac{{N}_{p}^{2}}{{C}_{r s} {N}_{s}^{2}}}$$

The primary resonant circuit and the secondary resonant circuit comprise a total resonant inductance; and the total resonant inductance being:

$${L}_{r e s} = {L}_{r p} + {L}_{r s} {( \frac{{N}_{p}}{{N}_{s}} )}^{2}$$

A resonant frequency, the resonant frequency being equal to:

$${f}_{r e s} = \frac{1}{2 π \sqrt{{L}_{r e s} + {C}_{r e s}}}$$

wherein Lᵣₑₛ may be a total resonant inductance; and wherein Cᵣₑₛ may be a total resonant capacitance. The first set of switches and second set of switches are switches selected from the group consisting of one or more of: power MOSFET and diode, IGBT, BJT, and thyristor. The first set of switches being configured as an H-bridge circuit; and the second set of switches being configured as an H-bridge circuit. The switching frequency being configured to control the efficiency of the balanced bi-directional CLLC transformer circuit.

An alternative embodiment of the present disclosure may be a reduced common mode EMI balanced bi-directional capacitor-inductor-inductor-capacitor solid-state transformer (SST) comprising: a first converter comprising a first set of switches, the first converter configured as an H-bridge circuit; a second converter comprising a second set of switches, the second converter configured as an H-bridge circuit; a primary resonant circuit comprising a Va1 tank circuit and a Vb1 tank circuit, the Va1 tank circuit having an impedance, the Vb1 tank circuit having an impedance, the Va1 tank circuit impedance may be equivalent to the Vb1 tank circuit impedance, the Va1 tank circuit and a Vb1 tank circuit being balanced across the primary winding of the transformer and configured to filter common mode electromagnetic interference (EMI); the first converter being electrically coupled to the primary resonant circuit, the Va1 tank circuit being electrically coupled to an L1 of a primary winding of a transformer, and the Vb1 tank circuit being electrically coupled to an L2 of the primary winding of the transformer; a secondary resonant circuit comprising a Va2 tank circuit and a Vb2 tank circuit, the Va2 tank circuit having an impedance, the Vb2 tank circuit having an impedance, the Va2 tank circuit impedance may be equivalent to the Vb2 tank circuit impedance, the Va2 tank circuit and a Vb2 tank circuit being balanced across the primary winding of the transformer and configured to filter common mode electromagnetic interference (EMI); and the second converter being electrically coupled to the secondary resonant circuit, the Va2 tank circuit being electrically coupled to an L1 of a secondary winding of the transformer; and the Vb2 tank circuit being electrically coupled to an L2 of the secondary winding of the transformer. The Va1 tank circuit comprising a first resonant inductor and a first resonant capacitor, the first resonant inductor being electrically coupled to the first resonant capacitor of the Va1 tank circuit; the Vb1 tank circuit comprising a second resonant inductor and a second resonant capacitor, the second resonant inductor being electrically coupled to the second resonant capacitor of the Vb1 tank circuit; the Va2 tank circuit comprising a third resonant inductor and a third resonant capacitor, the third resonant inductor being electrically coupled to the third resonant capacitor of the Va2 tank circuit; and the Vb2 tank circuit comprising a fourth resonant inductor and a fourth resonant capacitor, the fourth resonant inductor being electrically coupled to the fourth resonant capacitor of the Vb2 tank circuit. The primary resonant circuit and the secondary resonant circuit comprise a total resonant capacitance; and the total resonant capacitance being:

$${C}_{r e s} = \frac{1}{\frac{1}{{C}_{r p}} + \frac{1}{{C}_{r p}} + \frac{{N}_{p}^{2}}{{C}_{r} s {N}_{s}^{2}} + \frac{{N}_{p}^{2}}{{C}_{r s} {N}_{s}^{2}}}$$

The primary resonant circuit and the secondary resonant circuit comprise a total resonant inductance; and the total resonant inductance being:

$${L}_{r e s} = {L}_{r p} + {L}_{r s} {( \frac{{N}_{p}}{{N}_{s}} )}^{2}$$

The resonant frequency being equal to:

$${f}_{r e s} = \frac{1}{2 π \sqrt{{L}_{r e s} + {C}_{r e s}}}$$

wherein Lᵣₑₛ may be a total resonant inductance; and wherein Cᵣₑₛ may be a total resonant capacitance. The first set of switches and second set of switches are switches selected from the group consisting of one or more of: power MOSFET and diode, IGBT, BJT, and thyristor. A switching frequency, the switching frequency being configured to control the efficiency of the balanced bi-directional CLLC transformer circuit.

A method of reducing common mode EMI, the method comprising: by a bi-directional wide bandgap capacitor-inductor-inductor-capacitor (CLLC) resonant converter in a forward direction of current flow: receiving current from a power source, by a first converter, wherein the power source may be a first direct current power source; controlling the flow of current into a primary resonant circuit, by controlling the first converter, wherein the primary resonant circuit may be balanced across a primary winding of a transformer; adjusting the voltage across the transformer, by a turn ratio of the primary winding and a second winding of the transformer; receiving current from the transformer by a second resonant circuit, wherein the second resonant circuit may be balanced across a second winding of the transformer; receiving current from the second resonant circuit by a second converter; delivering current from the second converter to a load; controlling the flow of current to the load by controlling the second converter; by a bi-directional wide bandgap capacitor-inductor-inductor-capacitor (CLLC) resonant converter in a reverse direction of current flow: receiving current from the second power side, by the second set of switches, wherein the second power side may be a direct current power source; controlling the flow of current into the second resonant circuit, by controlling the second set of switches, wherein the second resonant circuit may be balanced across the second winding of a transformer; adjusting the voltage across the transformer, by a turn ratio of the first winding and a second winding of the transformer; receiving current from the transformer by the first resonant circuit, wherein the first resonant circuit may be balanced across the first winding of the transformer; receiving current from the first resonant circuit by the first set of switches; delivering current from the first set of switches to the first power side; and controlling the flow of current to the first power side by controlling the first set of switches. A first switching frequency of the one or more primary switch and a secondary switching frequency of the one or more secondary switches may control the efficiency of the wide bandgap CLLC resonant converter. The balanced primary resonant circuit filters common mode electromagnetic interference (EMI); and wherein the balanced secondary resonant circuit filters common mode EMI.

It is an object to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fec.

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a schematic illustration of an unbalanced bi-directional solid-state transformer circuit.

FIG. 2 is a schematic illustration of a balanced bi-directional SST circuit.

FIG. 3 is a graph of the measured line impedance stabilization network (LISN) voltages added together and divided by 2, comparing plotted voltage between an unbalanced and a balanced bi-directional SST circuit

FIG. 4A-4B are process flow block diagrams of one embodiment of a method of reducing EMI by a balanced bi-directional SST circuit in the forward and reverse direction of current flow.

FIG. 5 is a schematic illustration of a diagonally balanced bi-directional SST circuit.

### DETAILED DESCRIPTION OF THE ILLUSTRATIVE EMBODIMENTS

In the following detailed description of various embodiments of the present disclosure, numerous specific details are set forth in order to provide a thorough understanding of various aspects of one or more embodiments of the present disclosure. However, one or more embodiments of the present disclosure may be practiced without some or all of these specific details. In other instances, well-known methods, procedures, and/or components have not been described in detail so as not to unnecessarily obscure aspects of embodiments of the present disclosure.

While multiple embodiments are disclosed, still other embodiments of the devices, systems, and methods of the present disclosure will become apparent to those skilled in the art from the following detailed description, which shows and describes illustrative embodiments of the devices, systems, and methods of the present disclosure. As will be realized, the devices, systems, and methods of the present disclosure are capable of modifications in various obvious aspects, all without departing from the spirit and scope of the present disclosure. Accordingly, the screenshot figures, and the detailed descriptions thereof, are to be regarded as illustrative in nature and not restrictive. Also, the reference or non-reference to a particular embodiment of the devices, systems, and methods of the present disclosure shall not be interpreted to limit the scope of the present disclosure.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

Furthermore, the one or more versions may be implemented as a method, apparatus, or article of manufacture using standard programming and/or engineering techniques to produce entirely hardware embodiment, an entirely software embodiment, or an embodiment combining software and hardware embodiments. Furthermore, the systems and methods may take the form of Non-transitory computer readable media. More particularly, the present methods and systems may take the form of web-implemented computer software or a computer program product. Any suitable computer-readable storage medium may be utilized including, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick).

Those skilled in the art will recognize many modifications may be made to this configuration without departing from the scope of the disclosed embodiments.

Embodiments of the systems and methods are described below with reference to schematic diagrams, block diagrams, and flowchart illustrations of methods, systems, apparatuses and computer program products. It will be understood that each block of the block diagrams, schematic diagrams, and flowchart illustrations, and combinations of blocks in the block diagrams, schematic diagrams, and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

In the following description, certain terminology is used to describe certain features of the various embodiments of the device, method, and/or system. For example, as used herein, the terms “computer” and “computer system” generally refer to any device that processes information with an integrated circuit chip and/or central processing unit (CPU).

As used herein, the terms “software” and “application” refer to any set of machine-readable instructions on a machine, web interface, and/or computer system” that directs a computer's processor to perform specific steps, processes, or operations disclosed herein.

As used herein, the term “computer-readable medium” refers to any storage medium adapted to store data and/or instructions that are executable by a processor of a computer system. The computer-readable storage medium may be a computer-readable non-transitory storage medium and/or any non-transitory data storage circuitry (e.g., buggers, cache, and queues) within transceivers of transitory signals. The computer-readable storage medium may also be any tangible computer readable medium. In various embodiments, a computer readable storage medium may also be able to store data, which is able to be accessed by the processor of the computer system.

As used herein, the term “Band gap” refers to the energy difference between the valence band's top and the conduction band's bottom in semiconductors.

As used herein, the term “common mode” or “CM” refers to electromagnetic interference that occurs along the lines of a closed loop simultaneously in the same direction and in phase current with respect to a common reference ground.

As used herein, the term “electromagnetic interference (EMI)” refers to unwanted noise or interference in an electrical path or circuit.

As used herein, the term “resonance” refers to a condition in an RLC circuit where the capacitive and inductive reactance are equal in magnitude, resulting in a purely resistive impedance.

As used herein, the term “solid-state transformer (SST)” refers to a collection of high-powered semiconductor components, conventional high-frequency transformers, and control circuitry that provides a high degree of flexibility and control to power distribution networks.

As used herein, the term “wide bandgap” or “wide band gap semiconductors” refers to semiconductor materials with a larger band gap than conventional semiconductors. Conventional semiconductors, like silicon, have a band gap of 0.6-1.5 electron volts, while WBG materials have band gaps above 2 electron volts.

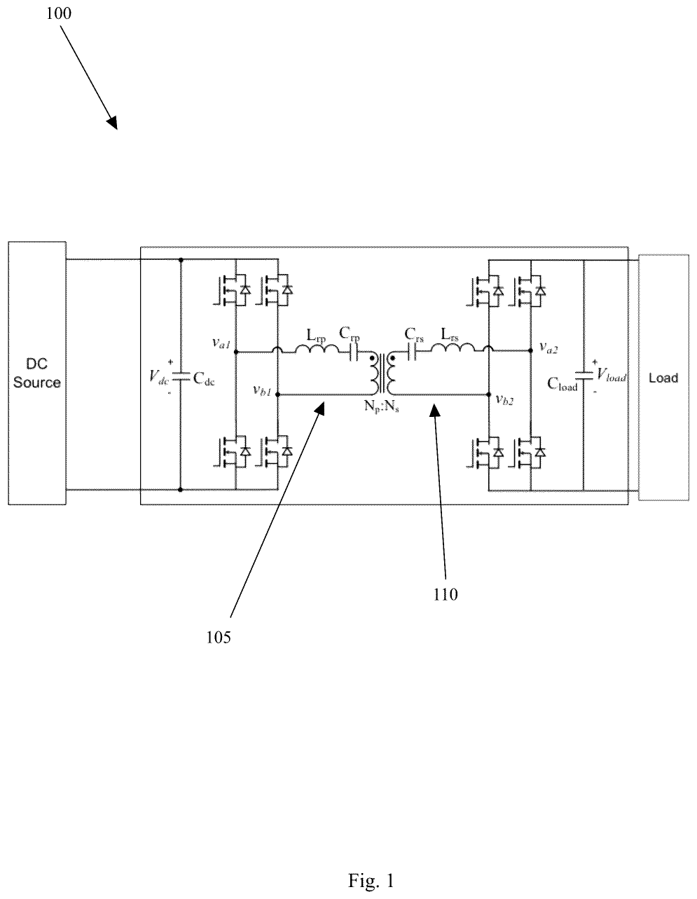

FIG. 1 is a schematic illustration of an unbalanced bi-directional solid-state transformer (SST) circuit. As shown in FIG. 1, the unbalanced bi-directional solid-state transformer (SST) circuit 100 has no filtering at signal return 105 of the primary transformer winding, nor does it have filtering at the signal return 110 of the secondary transformer winding. Without any filtering or method of suppressing common mode (CM) electromagnetic interference (EMI) on this portion of a bi-directional solid-state transformer 100 CM EMI may manifest itself on the circuit and potentially limit the switching rate of the circuit. Any manifestation of CM EMI may be amplified and conducted to other elements of the unbalanced bi-directional solid-state transformer (SST) circuit 100, causing interference to the unbalanced bi-directional solid-state transformer (SST) circuit 100. The CM EMI may also be externally radiated and may cause EMI on external circuits or systems.

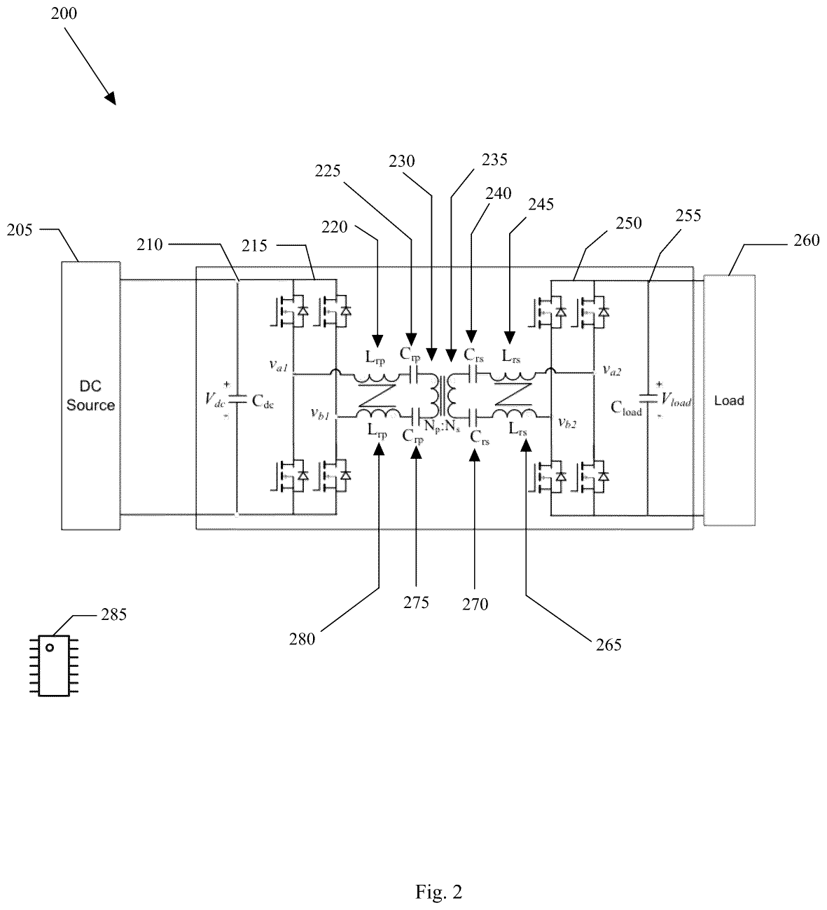

FIG. 2 is a schematic illustration of a balanced bi-directional SST circuit. Balanced Bi-directional SST circuit 200 may include power source 205, capacitor 210, converter 215, first resonant inductor 220, first resonant capacitor 225, transformer primary winding 230, transformer secondary winding 235, third resonant capacitor 240, third resonant inductor 245, converter 250, capacitor 255, load 260, fourth resonant inductor 265, fourth resonant capacitor 270, second resonant capacitor 275, second resonant inductor 280, and controller 285.

Converter 215 and converter 250 may be one or more switches, preferably MOSFETs or another fast-switching device. Converter 215 may control the flow of current from power source 205. Converter 215 and converter 250 may be controlled by controller 285, including but not limited to an FPGA, microcontroller, oscillating circuit, or any other control or regulating circuits. Converter 215 and converter 250 may be, but should not be limited to, an H-bridge configuration. An H-Bridge configuration may convert direct current (DC) to alternating current (AC) utilizing four active switching components across a power transformer. An H-bridge may also be referred to as a full bridge converter commonly used for isolation, stepping up or down a voltage, and a pure wave inverter for converting DC to AC.

Balanced bi-directional SST circuit 200 may include primary and secondary resonant circuits. A primary resonant circuit may include first inductor 220, first capacitor 225, second capacitor 275, and second inductor 280. First inductor 220 and first capacitor 225 may be configured as Va1 tank circuit. Second inductor 280 and second capacitor 275 may be configured as Vb1 tank circuit. It is preferable to have the impedance of the Va1 tank circuit equal to the impedance of the Vb1 tank circuit. A secondary resonant circuit may include third capacitor 240, third inductor 245, fourth capacitor 270, and fourth inductor 265. Third inductor 245 and third capacitor 240 may be configured as Va2 tank circuit. Fourth inductor 265 and fourth capacitor 270 may be configured as a Vb2 tank circuit. It is preferable to have the impedance of Va2 tank circuit equal the impedance of Vb2 tank circuit. A primary resonant circuit preferably distributes the inductance (Lrp) and capacitance (Crp) across primary winding 230. For example, the Va1 tank circuit would be electrically coupled to L1 of primary winding 230, and the Vb1 tank circuit would be electrically coupled to L2 of primary winding 230. A secondary resonant circuit preferably distributes the inductance (Lrs) and capacitance (Crs) across secondary winding 235. For example, the Va2 tank circuit would be electrically coupled to L1 of secondary winding 235, and the Vb2 tank circuit would be electrically coupled to L2 of secondary winding 235. Primary and secondary resonant circuits may be mirror circuits of each other. For example, first inductor 220 may be equivalent to third inductor 245, first capacitor 225 may be equivalent to third capacitor 240, second inductor 280 may be equivalent to fourth inductor 265, and second capacitor 275 may be equivalent to fourth capacitor 270. Additionally, the Va1 tank circuit would be equivalent to the Va2 tank circuit, and the Vb1 tank circuit would be equivalent to the Vb2 tank circuit. Because the inductance (Lrp) and the capacitance (Crp) of the primary resonant circuit are distributed across primary winding 230 and the inductance (Lrs) and the capacitance (Crs) of the secondary resonant circuit are distributed across secondary winding 235 in addition to primary winding 230 and secondary winding 235, balanced bi-directional SST circuit 200 may be represented by a total resonant inductance (Lres), a total resonant capacitance (Cres), and a resonant frequency (fres), where Np is the number of windings in primary winding 230, and Ns is the number of windings in secondary winding 235.

$${L}_{r e s} = {L}_{rp} + {L}_{rs} {( \frac{{N}_{p}}{{N}_{S}} )}^{2}$$

$${C}_{res} = \frac{1}{\frac{1}{{C}_{rp} +} \frac{1}{{C}_{r p}} + \frac{{N}^{2} p}{{C}_{rs} {N}_{s}^{2}} + \frac{{N}^{2} p}{{C}_{r s} {N}_{s}^{2}}}$$

When converter 215 and/or 250 are controlled by controller 285 to switch at a rate near the resonant frequency (fᵣₑₛ), zero-current/zero-voltage switching occurs. Zero-current/zero voltage switching ensures that a switch is open at the moment of zero voltage and closed at the moment when zero current flows through it. Zero-current/zero voltage switching may reduce switching losses, negative effects of inrush current, circuit breaker tripping, and EMI. It is preferable that the switching frequency be maintained at a frequency greater than the resonant frequency.

$${f}_{r e s} = \frac{1}{2 π \sqrt{{L}_{res} + {C}_{res}}}$$

In one embodiment, CM EMI may be conducted through parasitic capacitances to ground and may be reduced in the forward flow of electrical current. Forward current may flow from power source 205, which may be but should not be limited to a DC power source which may be but should not be limited to a battery. Capacitor 210 may filter DM EMI. Converter 215 may produce CM EMI, noise, or transients that may be conducted through parasitic capacitances to ground. Forward current flows from converter 215 to a primary resonant circuit. The Primary resonant circuit may include first inductor 220, first capacitor 225, second capacitor 275, and second inductor 280. The primary resonant circuit may preferably distribute inductance and capacitance across transformer primary winding 230. Distributing the primary resonant inductance and capacitance across transformer primary winding 230 may filter and reduce CM EMI. Forward current flows from the primary resonant circuit through transformer primary winding 230. Forward current from transformer primary winding 230 is coupled to transformer secondary winding 235 through electromagnetic induction. The voltage and the flow of current from transformer primary winding 230 to transformer secondary winding 235 may be dependent on the turn ratio between transformer primary winding 230 and transformer secondary winding 235. Transformer primary winding 230 and transformer secondary winding 235 may also conduct CM EMI through parasitic capacitances to ground. Forward current from transformer secondary winding 235 flows to a secondary resonant circuit. The secondary resonant circuit may include third capacitor 240, third inductor 245, fourth capacitor 270, and fourth inductor 265. The secondary resonant circuit may preferably distribute inductance and capacitance across transformer secondary winding 235. Distributing the secondary resonant inductance and capacitance across transformer secondary winding 235 may filter and reduce CM EMI. Forward current flows from the secondary resonant circuit to converter 250. Forward current from converter 250 may flow to load 260. Converter 250 may produce CM EMI, noise, or transients that may be conducted through parasitic capacitance to ground. Capacitor 255 may filter rippler, smooth transients, and correct voltage lags. Load 260 may be one or more electrical loads such as but not limited to AC motor. AC grid, DC battery, DC system, or any combination thereof.

The balanced Bi-directional SST circuit 200 may operate in the reverse direction. Load 260 may not only consume electrical energy but may also produce and be a source of electrical energy. Power source 205 may not only source electrical energy but may also absorb or charge from electrical energy produced by load 260.

In a second embodiment, CM EMI may be conducted through parasitic capacitances to ground and may be reduced in the electrical current's reverse flow. Reverse current may flow from load 260, which may be one or more electrical loads such as but not limited to AC motor, AC grid, DC battery, DC system, or any combination thereof. Capacitor 255 may filter DM EMI. Converter 250 may produce CM EMI, noise, or transients that may be conducted through parasitic capacitances to ground. Reverse current flows from converter 250 to a secondary resonant circuit. The secondary resonant circuit may include third capacitor 240, third inductor 245, fourth capacitor 270, and fourth inductor 265. The secondary resonant circuit may preferably distribute inductance and capacitance across transformer secondary winding 235. Distributing the secondary resonant inductance and capacitance across transformer secondary winding 235 may filter and reduce CM EMI. Reverse current flows from the secondary resonant circuit through transformer secondary winding 235. Reverse current from transformer secondary winding 235 is coupled to transformer primary winding 230 through electromagnetic induction. The voltage and current flow from transformer secondary winding 235 to primary winding 230 may depend on the turn ratio between transformer primary winding 230 and transformer secondary winding 235. Transformer primary winding 230 and transformer secondary winding 235 may also conduct CM EMI through parasitic capacitances to ground. Reverse current from transformer primary winding 230 flows to the primary resonant circuit. The Primary resonant circuit may include first inductor 220, first capacitor 225, second capacitor 275, and second inductor 280. The primary resonant circuit may further distribute inductance and capacitance across transformer primary winding 230. Distributing the primary resonant inductance and capacitance across transformer primary winding 230 may filter and reduce CM EMI. Reverse current flows from the primary resonant circuit to converter 215. Reverse current from converter 215 may flow to power source 205. Converter 215 may produce CM EMI, noise, or transients that may be conducted through parasitic capacitance to ground. Capacitor 210 may filter ripple, smooth transients, and correct voltage lags. Power source 205 may be, but should not be limited to, a DC power source, which may be but should not be limited to a battery.

The balanced Bi-directional SST circuit 200 may operate in the forward direction. Power source 205 may absorb or recharge from reverse electrical energy and source or provide electrical energy. Load 260 may produce electrical energy and consume and be a load for electrical energy.

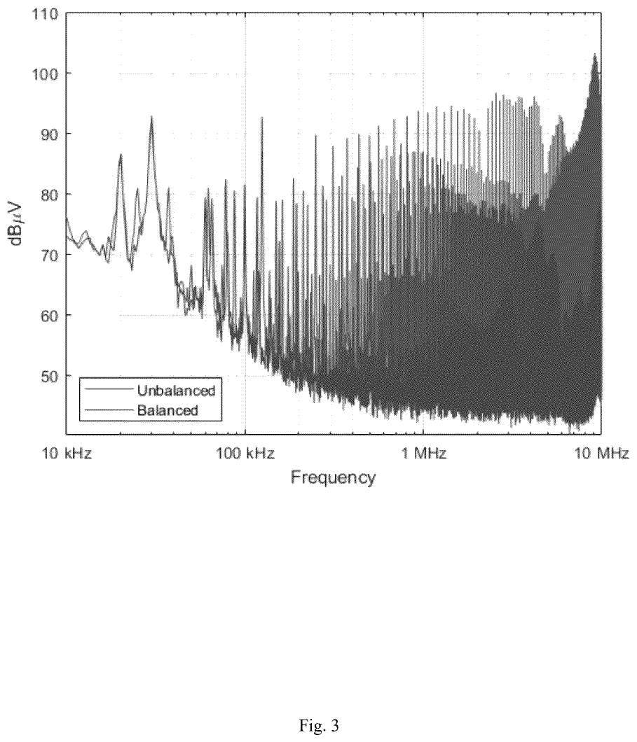

FIG. 3 is a graph of the measured line impedance stabilization network (LISN) voltages added together and divided by 2, comparing plotted voltage between an unbalanced and a balanced bi-directional SST circuit. Using a switching frequency of 39 kHz for the balanced bi-directional SST circuit and 62.5 kHz for the unbalanced SST circuit, the two largest harmonics in FIG. 3 are observed at twice the switching frequency, 82 dBμV at 78 kHz for a balanced bi-directional SST circuit, and 93 dBμV at 125 kHz for the unbalanced CLLC SST. As shown in FIG. 3, CM EMI may be reduced by 11 dB when a balanced bi-directional SST circuit is used. The balanced bi-directional SST circuit may significantly reduce CM EMI at frequencies above 100 kHz compared to the unbalanced CLLC SST. CM EMI may be attenuated by 10-20 dB above 1 MHz, demonstrating that CM EMI may be reduced by balancing the LC resonant tank across a transformer.

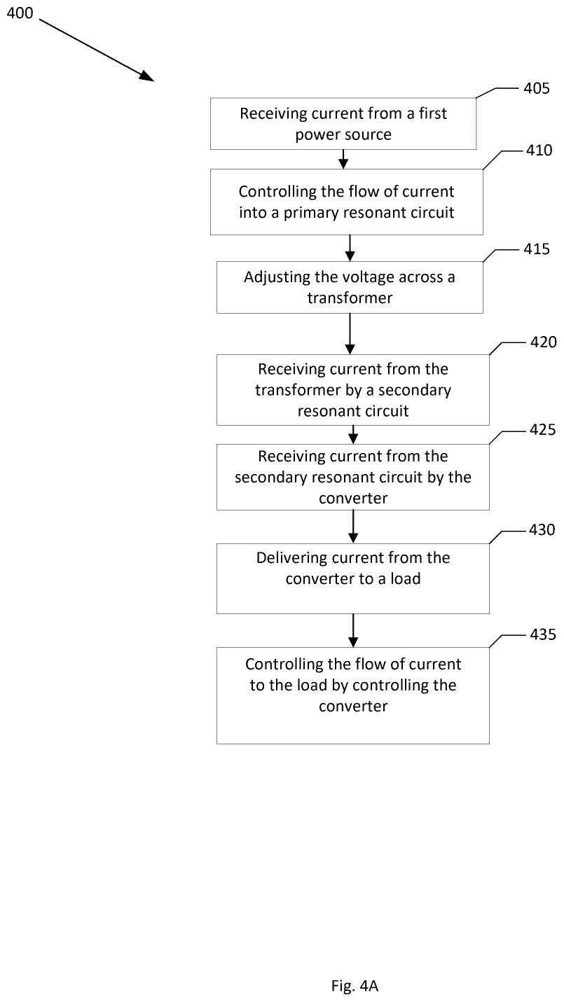

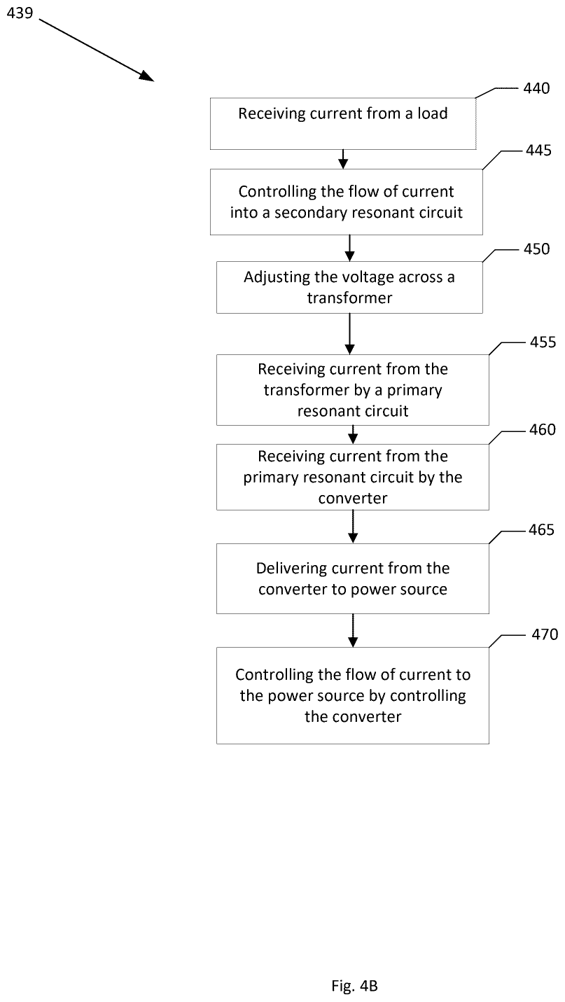

FIG. 4A-4B are process flow block diagrams of one embodiment of a method of reducing EMI by a balanced bi-directional SST circuit in the forward and reverse direction of current flow.

Currently, in the forward direction 400, as shown in FIG. 4A, the method may comprise the steps:

Receiving 405 current from a power source. Power source 205 may be a DC power source, such as but not limited to DC batteries.

Controlling 410 is the flow of current into a first resonant circuit by regulating the duty cycle of the converter 215, as shown in FIG. 2. Controlling 410 may include stepping up or down a voltage or creating a pure AC wave by inverting DC to AC. The first resonant circuit may preferably distribute its inductance and capacitance across the transformer's primary windings. Distributing the inductance and capacitance across the primary windings may filter and reduce CM EMI.

Adjusting the voltage 415 across a transformer. The turn ratio may vary voltages between the primary and secondary windings of the transformer but may, in the alternative, be controlled by controller 285 in conjunction with converter 215.

Receiving current 420 from the transformer secondary winding 235 by a secondary resonant circuit. The secondary resonant circuit may preferably distribute its inductance and capacitance across the secondary windings of the transformer. Distributing the inductance and capacitance across the secondary windings may filter and reduce CM EMI.

Receive the current 425 from the second resonant circuit using the converter 250. The converter 250 may be controlled by controller 285. Controller 285 may regulate the duty cycle of the converter 250, as shown in FIG. 2. Controller 285 may step up or down a voltage or rectify an AC wave by converting AC to DC.

Delivering 430 current from the converter 250 to the load 260. Converter 250 may provide DC or AC to load 260. Load 260 may be one or more electrical loads such as but not limited to AC motor, AC grid, DC battery, DC system, or any combination thereof.

Controlling 435 the current flow to the load 260 by the converter 250. Converter 215 may be controlled by controller 285. Controller 285 may regulate the duty cycle of the converter 250. Controller 285 may step up or down a voltage or rectify an AC wave by converting AC to DC.

Current in the reverse direction 439, as shown in FIG. 4B, the method may comprise the steps:

Receiving 440 current from a load. Load 260 may be one or more electrical loads such as but not limited to AC motor, AC grid, DC battery, DC system, or any combination thereof.

Controlling 445 the flow of current into a secondary resonant circuit by regulating the duty cycle of converter 250, as shown in FIG. 2. Controlling 445 may include stepping up or down a voltage or creating a pure AC wave by inverting DC to AC. The secondary resonant circuit may preferably distribute its inductance and capacitance across the secondary windings of the transformer. Distributing the inductance and capacitance across the secondary windings may filter and reduce CM EMI.

Adjusting the voltage 450 across a transformer. The turn ratio may vary voltages between the primary and secondary sides of the transformer but may, in the alternative, be controlled by controller 285.

Receiving current 455 from the transformer primary winding 230 by a primary resonant circuit. The primary resonant circuit may preferably distribute its inductance and capacitance across the secondary windings of the transformer. Distributing the inductance and capacitance across the secondary windings may filter and reduce CM EMI.

Receiving current 460 from the primary resonant circuit by the converter 215. Converter 215 may be controlled by controller 285. Controller 285 may regulate the duty cycle of converter 215, as shown in FIG. 2. Controller 285 may step up or down a voltage or rectify an AC wave by converting AC to DC.

Delivering 465 current from the converter 215 to the power source 205. Converter 215 may provide DC or AC to power source 205.

Controlling 470 the current flow to the power source 205 by the converter 215. Converter 215 may be controlled by controller 4285. Controller 285 may regulate the duty cycle of the converter 250. Controller 285 may step up or down a voltage or rectify an AC wave by converting AC to DC.

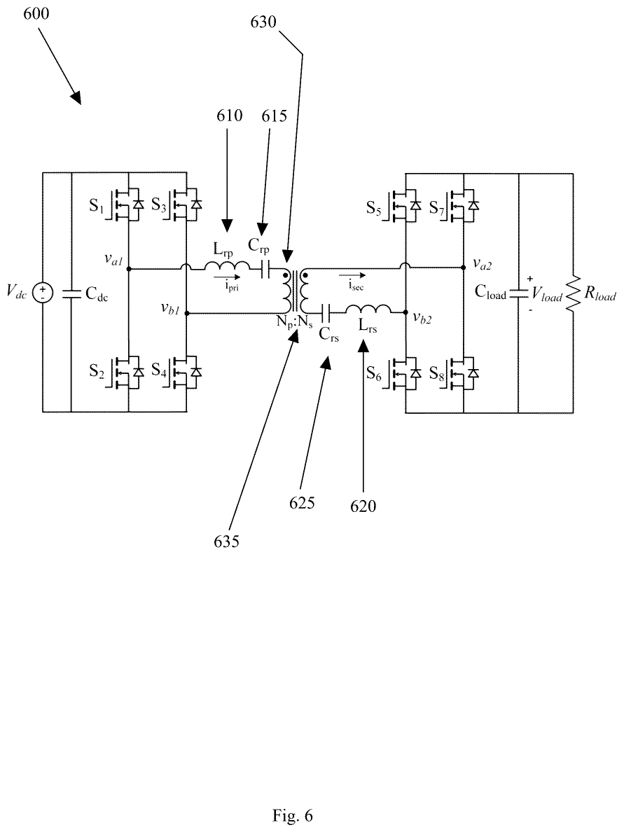

FIG. 5 is a schematic illustration of a diagonally balanced bi-directional SST circuit. To save costs and/or minimize the number of components of a balanced bi-directional SST circuit, a diagonally balanced bi-directional SST circuit topology may be implemented. A diagonally balanced bidirectional SST 600 circuit may include a primary resonant circuit and a secondary resonant circuit. A primary resonant circuit may include first inductor 610 and first capacitor 615. A secondary resonant circuit may include second inductor 620 and second capacitor 625.

A primary resonant circuit may preferably be installed at the L1 of transformer primary winding 630. As shown in FIG. 6 the inductance and capacitance of first inductor 610 and first capacitor 615 are not distributed across primary winding 630.

A Secondary resonant circuit may preferably be installed at the L2 of transformer secondary winding 635. As shown in FIG. 6, the inductance and capacitance of second inductor 620 and second capacitor 625 are not distributed across secondary winding 635.

As shown in FIG. 6, the primary resonant circuit is diagonal from the secondary resonant circuit. In contrast to the distributed inductance and capacitance across the windings of a transformer as in balanced bi-directional SST circuit 200 of FIG. 2, diagonally balanced bi-directional SST 600 takes advantage of filtering and reducing CM EMI caused by parasitic capacitances to ground with a reduced number of components.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

Some portions of the preceding detailed descriptions have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the present disclosure, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The processes or methods depicted in the figures may be performed by processing logic that comprises hardware (e.g., circuitry, dedicated logic, etc.), firmware, software (e.g., embodied on a non-transitory computer readable medium), or a combination thereof. Although the processes or methods are described above in terms of some sequential operations, it should be appreciated that some of the operations described may be performed in a different order. Moreover, some operations may be performed in parallel rather than sequentially.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A balanced bi-directional capacitor-inductor-inductor-capacitor transformer circuit comprising:
a transformer comprising a primary winding and a secondary winding;
a first converter comprising a first set of switches, the first converter being electrically coupled to the primary winding of the transformer;
a second converter comprising a second set of switches, the second converter being electrically coupled to the secondary winding of the transformer;
a primary resonant circuit that is:
balanced across the primary winding of the transformer and filters common mode electromagnetic interference (EMI), and
electrically coupled to the primary winding of the transformer; and
a secondary resonant circuit that is:
balanced across the secondary winding of the transformer and the filters common mode EMI, and
electrically coupled to the secondary winding of the transformer.

2. The circuit of claim 1,
the primary resonant circuit further comprising a Va1 tank circuit and a Vb1 tank circuit;
the secondary resonant circuit further comprising a Va2 tank circuit and a Vb2 tank circuit;
the Va1 tank circuit further comprising an impedance, the Vb1 tank circuit further comprising an impedance, the Va1 tank circuit impedance being equivalent to the Vb1 tank circuit impedance; and
the Va2 tank circuit further comprising an impedance, the Vb2 tank circuit further comprising an impedance, the Va2 tank circuit impedance being equivalent to the Vb2 tank circuit impedance.

3. The circuit of claim 2,
the Va1 tank circuit being electrically coupled to an L1 of the primary winding of the transformer;
the Vb1 tank circuit being electrically coupled to an L2 of the primary winding of the transformer;
the Va2 tank circuit being electrically coupled to an L1 of the secondary winding of the transformer; and
the Vb2 tank circuit being electrically coupled to an L2 of the secondary winding of the transformer.

4. The circuit of claim 3,
the Va1 tank circuit comprising a first resonant inductor and a first resonant capacitor, and the first resonant inductor and the first resonant capacitor of the Va1 tank circuit being electrically coupled;
the Vb1 tank circuit comprising a second resonant inductor and a second resonant capacitor, and the second resonant inductor and the second resonant capacitor of the Vb1 tank circuit being electrically coupled;
the Va2 tank circuit comprising a third resonant inductor and a third resonant capacitor, and the third resonant inductor and the third resonant capacitor of the Va2 tank circuit being electrically coupled; and
the Vb2 tank circuit comprising a fourth resonant inductor and a fourth resonant capacitor, and the fourth resonant inductor and the fourth resonant capacitor of the Vb2 tank circuit being electrically coupled.

5. The circuit of claim 4,
the primary resonant circuit and the secondary resonant circuit comprise a total resonant capacitance; and
the total resonant capacitance being:
$${C}_{res} = \frac{1}{\frac{1}{{C}_{rp}} + \frac{1}{{C}_{rp}} + \frac{{N}^{2} p}{{C}_{rs} {N}_{s}^{2}} + \frac{{N}^{2} p}{{C}_{rs} {N}_{s}^{2}}} .$$

6. The circuit of claim 4,
the primary resonant circuit and the secondary resonant circuit comprise a total resonant inductance; and
the total resonant inductance being:
$${L}_{res} = {L}_{r p} + {L}_{r s} {( \frac{{N}_{p}}{{N}_{S}} )}^{2} .$$

7. The circuit of claim 1, further comprising a resonant frequency, the resonant frequency being equal to:
$${f}_{res} = \frac{1}{2 π \sqrt{{L}_{r e s} + {C}_{r e s}}}$$
wherein Lᵣₑₛ is a total resonant inductance; and
wherein Cᵣₑₛ is a total resonant capacitance.

8. The circuit of claim 1, the first set of switches and second set of switches are switches selected from the group consisting of one or more of: power MOSFET and diode, IGBT, BJT, and thyristor.

9. The circuit of claim 1,
the first set of switches being configured as an H-bridge circuit; and
the second set of switches being configured as an H-bridge circuit.

10. The circuit of claim 1, further comprising a switching frequency, the switching frequency being configured to control the efficiency of the balanced bi-directional CLLC transformer circuit.

11. A reduced common mode EMI balanced bi-directional capacitor-inductor-inductor-capacitor solid-state transformer (SST) comprising:
a first converter comprising a first set of switches, the first converter configured as an H-bridge circuit;
a second converter comprising a second set of switches, the second converter configured as an H-bridge circuit;
a primary resonant circuit comprising a Va1 tank circuit and a Vb1 tank circuit, the Va1 tank circuit having an impedance, the Vb1 tank circuit having an impedance, the Va1 tank circuit impedance is equivalent to the Vb1 tank circuit impedance, the Va1 tank circuit and a Vb1 tank circuit being balanced across the primary winding of the transformer and configured to filter common mode electromagnetic interference (EMI);
the first converter being electrically coupled to the primary resonant circuit, the Va1 tank circuit being electrically coupled to an L1 of a primary winding of a transformer, and the Vb1 tank circuit being electrically coupled to an L2 of the primary winding of the transformer;
a secondary resonant circuit comprising a Va2 tank circuit and a Vb2 tank circuit, the Va2 tank circuit having an impedance, the Vb2 tank circuit having an impedance, the Va2 tank circuit impedance is equivalent to the Vb2 tank circuit impedance, the Va2 tank circuit and a Vb2 tank circuit being balanced across the primary winding of the transformer and configured to filter common mode electromagnetic interference (EMI); and
the second converter being electrically coupled to the secondary resonant circuit, the Va2 tank circuit being electrically coupled to an L1 of a secondary winding of the transformer; and the Vb2 tank circuit being electrically coupled to an L2 of the secondary winding of the transformer.

12. The SST of claim 11,
the Va1 tank circuit comprising a first resonant inductor and a first resonant capacitor, the first resonant inductor being electrically coupled to the first resonant capacitor of the Va1 tank circuit;
the Vb1 tank circuit comprising a second resonant inductor and a second resonant capacitor, the second resonant inductor being electrically coupled to the second resonant capacitor of the Vb1 tank circuit;
the Va2 tank circuit comprising a third resonant inductor and a third resonant capacitor, the third resonant inductor being electrically coupled to the third resonant capacitor of the Va2 tank circuit; and
the Vb2 tank circuit comprising a fourth resonant inductor and a fourth resonant capacitor, the fourth resonant inductor being electrically coupled to the fourth resonant capacitor of the Vb2 tank circuit.

13. The SST of claim 12,
the primary resonant circuit and the secondary resonant circuit comprise a total resonant capacitance; and
the total resonant capacitance being:
$${C}_{res} = \frac{1}{\frac{1}{{C}_{rp}} + \frac{1}{{C}_{rp}} + \frac{{N}^{2} p}{{C}_{r} {sN}_{s}^{2}} + \frac{{N}^{2} p}{{C}_{rs} {N}_{s}^{2}}} .$$

14. The SST of claim 12,
the primary resonant circuit and the secondary resonant circuit comprise a total resonant inductance; and
the total resonant inductance being:
$${L}_{res} = {L}_{r p} + {L}_{r s} {( \frac{{N}_{p}}{{N}_{S}} )}^{2} .$$

15. The SST of claim 11, further comprising a resonant frequency, the resonant frequency being equal to:
$${f}_{res} = \frac{1}{2 π \sqrt{{L}_{r e s} + {C}_{r e s}}}$$
wherein Lᵣₑₛ is a total resonant inductance; and
wherein Cᵣₑₛ is a total resonant capacitance.

16. The SST of claim 11, the first set of switches and second set of switches are switches selected from the group consisting of one or more of: power MOSFET and diode, IGBT, BJT, and thyristor.

17. The SST of claim 11, further comprising a switching frequency, the switching frequency being configured to control the efficiency of the balanced bi-directional CLLC transformer circuit.

18. A method of reducing common mode EMI, the method comprising:
by a bi-directional wide bandgap capacitor-inductor-inductor-capacitor (CLLC) resonant converter in a forward direction of current flow:
receiving current from a power source, by a first converter, wherein the power source is a first direct current power source;
controlling the flow of current into a primary resonant circuit, by controlling the first converter, wherein the primary resonant circuit is balanced across a primary winding of a transformer;
adjusting the voltage across the transformer, by a turn ratio of the primary winding and a second winding of the transformer;
receiving current from the transformer by a second resonant circuit, wherein the second resonant circuit is balanced across a second winding of the transformer;
receiving current from the second resonant circuit by a second converter;
delivering current from the second converter to a load;
controlling the flow of current to the load by controlling the second converter;
by a bi-directional wide bandgap capacitor-inductor-inductor-capacitor (CLLC) resonant converter in a reverse direction of current flow:
receiving current from the second power side, by the second set of switches, wherein the second power side is a direct current power source;
controlling the flow of current into the second resonant circuit, by controlling the second set of switches, wherein the second resonant circuit is balanced across the second winding of a transformer;
adjusting the voltage across the transformer, by a turn ratio of the first winding and a second winding of the transformer;
receiving current from the transformer by the first resonant circuit, wherein the first resonant circuit is balanced across the first winding of the transformer;
receiving current from the first resonant circuit by the first set of switches;
delivering current from the first set of switches to the first power side; and
controlling the flow of current to the first power side by controlling the first set of switches.

19. The method of claim 18, wherein a first switching frequency of the one or more primary switch and a secondary switching frequency of the one or more secondary switches controls the efficiency of the wide bandgap CLLC resonant converter.

20. The method of claim 18, wherein the balanced primary resonant circuit filters common mode electromagnetic interference (EMI); and
wherein the balanced secondary resonant circuit filters common mode EMI.
